(19) United States
(12) Patent Application Publication
(10) Pub. No.: US 2007/0067464 A1
(43) Pub. Date: Mar. 22, 2007

(54) Authentication Protection Apparatus and Method

(76) Inventors: Andrei V. Bardachenko, Kiev (UA); Alex V. Kariman, Great Falls, VA (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/466,670

(22) Filed: Aug. 23, 2006

Related U.S. Application Data
(60) Provisional application No. 60/710,192, filed on Aug. 23, 2005.

(51) Int. Cl. G06F 15/16

(52) U.S. Cl. 709/227

(57) ABSTRACT

In one embodiment of the invention a method includes receiving at a server a packet from an application including information associated with the application in a sender field and a numeric representation of a connect function in a command field. A response packet is created and can be sent to the application. In some embodiments, the server creates a failed authentication notification packet and sends it to the application.

### CROSS-REFERENCE TO RELATED APPLICATIONS

This application claims priority to U.S. Provisional Application Ser. No. 60/710,192, filed Aug. 23, 2005, entitled “Simple Transaction and Authentication Protection (STAP),” the entire disclosure of which is hereby incorporated by reference.

### BACKGROUND

The invention relates generally to communications between computing applications and more particularly to the authentication and protection of data transferred and/or communicated between applications.

Thus, a need exists for an apparatus and method for providing secure transactions between various types of applications, and the ability to transfer a non-protected application into a protected application model.

### SUMMARY OF THE INVENTION

A method includes receiving at a server a packet from an application including information associated with the application in a sender field and a numeric representation of a connect function in a command field. The server creates a response packet. The creating a response packet includes placing a unique client identifier and a client/sender relation identifier in a sender field; generating a session key associated with the application; generating a transaction key associated with the application; calculating a packet check sum associated with the application and placing the packet check sum in a validation field; combining the transaction key with the session key using an XOR operation and placing the result into a transaction key packet field; calculating a hash-function associated with a secret code of the application and combining it with the session key using an XOR operation and place a result of the combination in an authentication packet field; and calculating a packet size and placing the packet size into a length packet field.

### BRIEF DESCRIPTION OF THE DRAWINGS

FIG. 1 is an illustration of an example simple STAP packet structure according to an embodiment of the invention.

FIG. 2 is an illustration of an example of a Sender field structure according to an embodiment of the invention.

FIG. 3 is an illustration of an example of a fixed length additional data STAP packet structure according to an embodiment of the invention.

FIG. 4 is an illustration of an example of a variable length additional data STAP packet structure according to an embodiment of the invention.

FIG. 5 is an illustration of an example of a client STAP packet structure according to an embodiment of the invention.

FIG. 6 is an illustration of an example of a server STAP packet structure according to an embodiment of the invention.

FIG. 7 is an illustration of an example of content of a Connect client STAP packet according to an embodiment of the invention.

FIG. 8 is an illustration of an example of content of a Connect server STAP packet according to an embodiment of the invention.

FIG. 9 is an illustration of an example of content of a Request client STAP packet according to an embodiment of the invention.

FIG. 10 is an illustration of an example of content of a Request server STAP packet according to an embodiment of the invention.

FIG. 11 is a schematic illustration of a system according to an embodiment of the invention.

### DETAILED DESCRIPTION

A simple transaction and authentication protection (STAP) system according to an embodiment of the invention can provide a flexible solution to organize protected and/or unprotected communications between a variety of types of applications, for example, electronic devices, software applications, and software applications including a client-server architecture. The system can be used to protect the authentication phase and transaction phase of an applications' communications.

The term “application” as used herein means any device or software, which interacts with other applications.

The term “client” as used herein means any application that requires authentication and/or protection.

The term “server” as used herein means the application that provides authentication and/or protection.

The term “session key” as used herein means a secure code, which is generated by the server and used during all subsequent transactions instead of a client's secret code.

The term “transaction key” as used herein means a secure code, which is generated by the server for each transaction, and used to protect the transaction.

The term “packet validation data” as used herein means the information that contains the check sum of the packet.

The term “packet validation” as used herein means an application routine, which determines whether the packet was changed during a transportation.

The term “client authentication” as used herein means a server's routine, which determines whether the packet was actually sent by the particular client.

The term “server authentication” as used herein means a client's routine, which determines whether the packet was actually sent by the server.

The types of STAP communications, STAP packet structures, actions needed to provide authentication and transactions protection, and sequences of these actions are described herein. The types or models of STAP applications communications can include a simple STAP model and a protected STAP model. A simple STAP model can be used, for example, in non-protected applications. A protected STAP model can be used, for example, in applications that require data protection.

Simple Stap Model

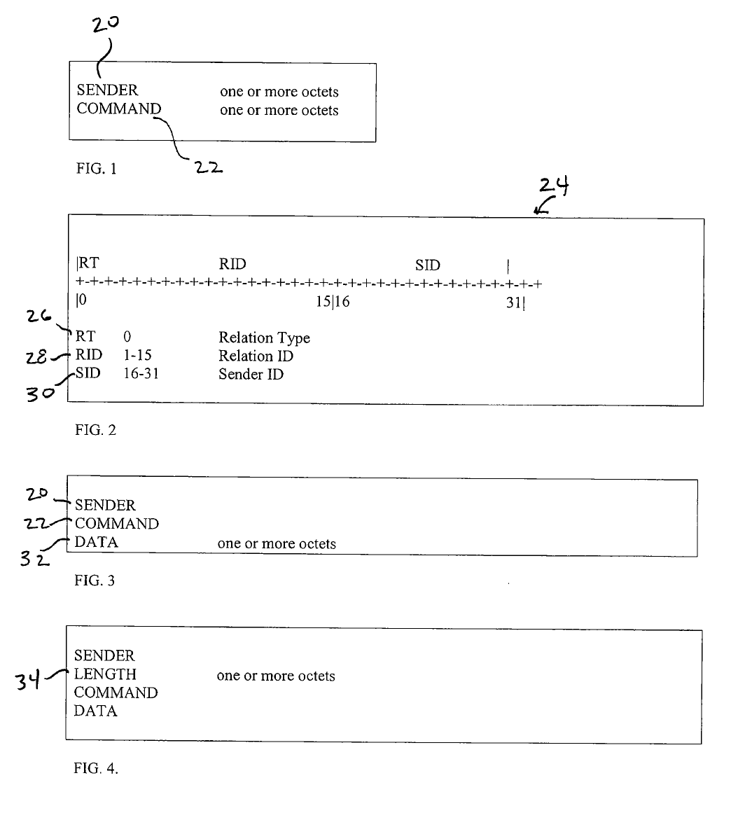

A simple STAP model can provide a flexible mechanism for developers to create new applications, or modify existing applications, which interact between themselves without data protection. The simple STAP model can also provide a mechanism to transfer these applications into a protected STAP model. In some embodiments, a simple STAP packet may contain only two fields: a “SENDER” field 20 and a “COMMAND” field 22, as shown in FIG. 1. In this embodiment, the application is a non-protected packet, which can be used for non-critical transactions between many types of applications. For example, this type of transaction can be used for notification messages between two or more applications. The “SENDER” field can contain information about the application that sent the command (or request). The “COMMAND” field 22 can contain information about the type of command or request that was received. Fields can have different lengths, which depends on the particular application requirements. In some embodiments, all fields have random lengths.

The structure of a SENDER field can be defined by various parameters. For example, for flexible interaction with higher-level software, including the Unified System for Applications Communication (USAC), an example of a structure for a “SENDER” field 24 that can be used is illustrated in FIG. 2. In other embodiments, other structures can be used, such as structures developed by a particular user or developer of an application. For example, such a structure may be desired when flexibility is not a primary requirement for the applications, or the applications do not interact with other external applications.

In one embodiment, such as with a USAC application, a “relation” is a type of ownership between a client and a server. As shown in the example SENDER field of FIG. 2, a relation type 26 can contain information about the sender type (e.g., client or server). A relation identification (ID) 28 can contain information about the application type (e.g., access point, device, database server, user's workstation, etc.), and sender ID 30 can contain information about an application unique identifier (UID).

In another embodiment, a STAP packet has a fixed length “additional data” field. For example, when an application needs to send more information to another application, the packet can include a “DATA” field 32 as shown in FIG. 3, which contains additional data for the current command. The DATA field 32 can contain any data structure if necessary. In some embodiments, a STAP packet may have a variable length additional data field. In such an embodiment, the packet can include a “LENGTH” field 34 as shown in FIG. 4, which contains information about the packet length. If a communication is configured for using a fixed data length, then a “LENGTH” field 34 is not required (see FIG. 3).

A simple STAP packet structure can provide a flexible solution to organize very different types of communications between any application that requires interactive transactions. Because authentication and data protection is not required, this communication type can be used between any type of application, not only between client and server.

Protected Stap Models

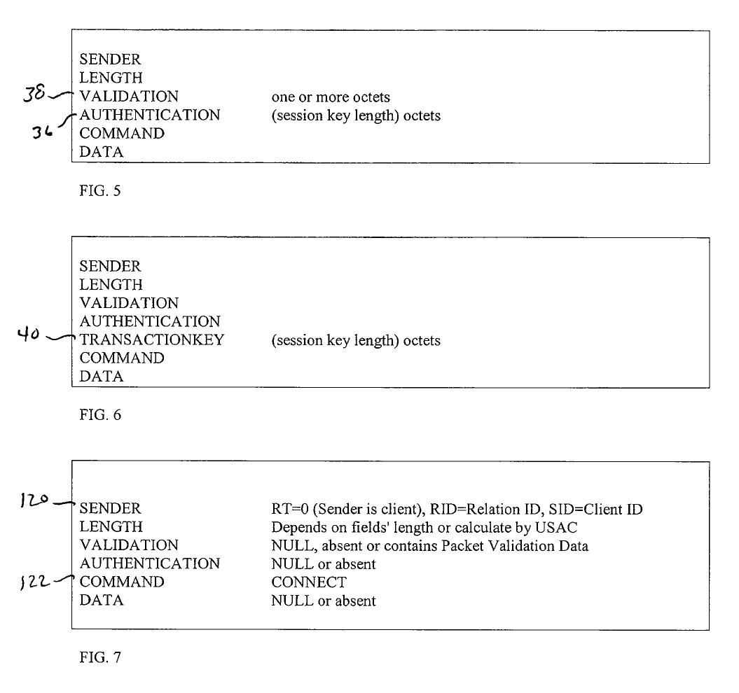

A protected STAP model can provide data protection during interactions between applications, including an authentication phase and a data exchange phase. Within this model there are various types of protected STAP packets, including, for example, a client's STAP packet and a server's STAP packet. In addition to information contained in a regular packet (see for example FIG. 4), a client packet can include data for authentication and a packet integrity control. For example, for client-server authentication, an “AUTHENTICATION” field 36 can be used, and for packet integrity control a “VALIDATION” field 38 can be used as well, as shown in FIG. 5. In this application, the length of the session key means the length that is preset by the STAP initial program for session keys. The order sequence to authenticate and protect the authentication data will be described below in the section entitled Authentication Protection.

In addition to information included in a client's packet (see for example FIG. 5), a server's packet can include a transaction key 40 that is used for the protection of transmitted data, such as is in the example of a server STAP packet structure illustrated in FIG. 6.

Authentication Protection

An example of an order sequence that can be used for the packet sender authentication and protection of the authentication data is as follows:

a) As shown in FIG. 7, which illustrates one example of a CONNECT client packet structure, the client sends the packet to the server in a “SENDER” field 120 in which the sender information is included (see also FIG. 2), and in the “COMMAND” field 122, the numeric representation of the CONNECT function is included. The remaining fields may contain meaningless data or be initiated by zeros. These fields may be absent in the view of the exact final STAP protocol implementation. A STAP packet can contain a different number of fields and be processed differently upon the exact final program processing.

b) The server extracts the information about the packet sender from the “SENDER” field 120. The server requests a specific information source in order to receive the client's secret code (this source may be a local file, which is stored on the PC hard drive, corporate database server, “electronic safe”, etc.).

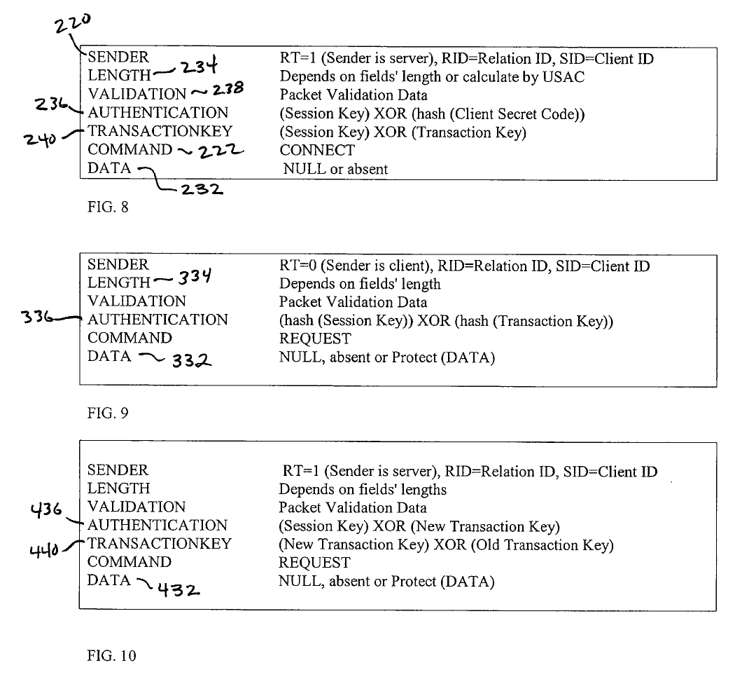

c) If a client does not exist in a server database, the server may generate a simple non-protected STAP packet that includes a failed authentication notification, and send this packet to the client. Also, the server may leave the client without a response. d) If a client's information was found in the server database, the server creates a response packet to the client. An example of such a packet is shown in FIG. 8. The server initiates the “SENDER” field 220 by a value, which contains the client UID, and information about the server and client relation, and the “COMMAND” field 222 by numeric CONNECT command representation.

e) The server generates the session key, which will be used instead of the client's real secret code for applications authentication during the next transaction. This raises the client secret code protection level, because the session key will be used instead of the client secret code in subsequent transactions. The session keys generator can be any software or hardware random generator.

f) The server generates the transaction key for protection of the current packet and subsequent client response.

g) The “DATA” field 232 may be empty or absent.

h) The server calculates the packet check sum using an algorithm, which is described below in the section entitled Packet Validation. The result of this calculation goes into the “VALIDATION” field 238.

i) The session key combines with the transaction key using the “excluding OR” (XOR) operation. The result of this calculation goes into the “TRANSACTIONKEY” packet field 240.

j) The server calculates the hash-function of the client secret code, and combines the result with the session key, using the “excluding OR” (XOR) operation. If the hash-function result length is smaller or bigger than the session key length, the XOR operation shall be imposed in a cycling sequence or be decreased to the key length. The result of this calculation fits in the “AUTHENTICATION” packet field 236.

k) The server calculates the packet size and the result of this calculation fits into the “LENGTH” packet field 234. In some applications, such as a STAP protocol implementation as a part of USAC, the packet size may not be calculated. A USAC unit implements this operation, based on the exact relation settings. After this step the server has a ready “CONNECT” packet as shown in FIG. 8.

The next operations are typically executed by a client application.

a) The client extracts the “SENDER” field value from the packet. If this value is not equal to the current client “SENDER” value, the client won't process this packet.

b) Extracts the “COMMAND” field value. If this value is not equal to the numeric representation of the “CONNECT” command, the client will process this packet as described in the next section entitled Transaction Protection.

c) Extracts the session key from the “AUTHENTICATION” field by the use of the XOR operation, imposing the result of the hash-function of the client secret code on this field, and the content of the “AUTHENTICATION” field.

d) Extracts the transaction from the “TRANSACTIONKEY” field by the use of the XOR operation imposed on the results of the previous operation (the session key).

e) Validates the packet integrity by the “VALIDATION” field content, using the mechanism described below in the section entitled Packet Validation.

f) If the packet wasn't validated, the client generates an exception and may not process the packet.

g) If the packet was validated, the client program may process next.

After the server packet is received and processed by the client, the client has a session key and transaction key for the next interaction with the server. This does not necessarily mean that the session key and transaction key were definitely sent by the server, as the packet could have been changed and the check sum could have been recalculated. This fact will be unknown until the client tries to interact with the server. In some embodiments, a STAP protocol can be configured for immediate checking of a valid session key and transaction keys. After the server has sent the packet, the server goes into client response listen mode, and if a timeout occurs and the server hasn't received the client response, an error may be generated by the server program. After the client receives the “CONNECT” packet, the “REQUEST” packet should be received by the server as described in more detail below. Processing this packet can enable a determination as to whether there has been a successful client authentication by the server.

Transaction Protection

This section describes the transaction phase of the interaction between applications. As described above, the server goes into a client response listen mode to validate the fact that the client authentication was successful. A “REQUEST” packet as illustrated in FIG. 9 can be sent by the client using a session key and a transaction key, which was received from the server in the previous “CONNECT” packet. In some cases, this “REQUEST” client packet will not differ from the next client packets. This can be sent to the server at a later time. The “REQUEST” packet is described as part of all the other packets, which transmits between the client and server. For example, the “REQUEST” packet can include data protection against non-authorized access while the communication channels data exchange is in process between interacting applications.

The following action sequence can be used for data protection and packet sender authentication:

a) Client creates a “REQUEST” packet as described above.

b) Client calculates the hash-function of the session key, which is received in the “CONNECT” server packet. The result of this operation fits in the “AUTHENTICATION” field .

c) Client fills in the “DATA” field 332 by additional data if necessary.

d) Client calculates the packet size. The result fits in the “LENGTH” field 334.

e) Client protects the “AUTHENTICATION” field 336 by combining this field with a session key hash-function result using an XOR operation.

f) Client protects the “DATA” field 332 by encrypting this field by any known cryptographic algorithm using a transaction key.

The result of the above-described operations is shown in FIG. 9, which includes an example of the content of the “REQUEST” client STAP Packet. The “Protect (DATA)” in the “DATA” field description means that any known cryptographic algorithm may be used for data protection.

When a server receives the packet from a client, the server can execute the following actions:

a) The server checks the “SENDER” field and the “COMMAND” field as described in the previous section.

b) The server extracts “AUTHENTICATION” field content by combining this field, using an XOR operation, with a transaction key hash-function.

c) Extracts the “DATA” field content like an “AUTHENTICATION” field.

d) Validates packet integrity.

e) Authenticates packet sender, comparing the result of step b) with the session key hash-function result.

Thus, each of the client STAP packets are protected, and the server can authenticate the sender of each of these packets. The following action sequence can be completed when the server sends a packet to a client:

a) The server executes all of the actions described above in the section entitled Authentication Protection, to begin the packet creation.

b) The server inserts the client session key into the “AUTHENTICATION” field 436, as shown in the example of a “REQUEST” server packet in FIG. 10.

c) The server generates a transaction key for packet protection, and following the client response protection, fits it into the “TRANSACTIONKEY” field.

d) The server inserts the “DATA” field 432 with additional data if necessary.

e) The server calculates the packet check sum.

f) The server protects the session key in the “AUTHENTICATION” field 436 by combining it with a transaction key using the XOR operation.

g) The server protects the new transaction key in the “TRANSACTIONKEY” field 440 by combining it with the old transaction key using the XOR operation.

h) The server protects the “DATA” field 432 by encrypting it with any known cryptographic algorithm.

A “REQUEST” server packet is ready after the fulfillment of the above-described actions, as shown in FIG. 10. The following actions can be completed when the client receives a packet from the server.

a) Client extracts the new transaction key by combining the “TRANSACTIONKEY” field content with the old transaction key using an XOR operation.

b) Client extracts the session key by combining the “AUTHENTICATION” field content with a new transaction key using the XOR operation.

c) Client compares the retrieved session key with its own session key.

d) Client extracts the “DATA” field by encrypting this field using a new transaction key.

e) Client validates packet integrity.

Packet Validation

The following actions can be used for a check sum calculation.

a) After all of the packet fields are filled in, but before the protection of the necessary fields, such as “AUTHENTICATION”, “TRANSACTIONKEY”, and “DATA”, the program can calculate the hash-function of all of the packet fields, excluding the “VALIDATION” field.

b) Depending on the “VALIDATION” field length, the result of the previous step may be processed using a special function for decreasing the length of the result. For example, STAP implementation as a part of USAC, provides the following algorithm for the “VALIDATION” length decrease to the length required (2 octets in USAC):
The retrieved result has a length of, for example, 16 octets (the length of message digest MD5 [5]).
First eight octets combine between each other using the XOR operation, and the result of this operation fits into the first “VALIDATION” field octet.
Second eight octets combine between each other using the XOR operation, and the result of this operation fits into the second “VALIDATION” field octet.

To validate the packet integrity, the program can execute the operations described below.

a) Extracts the “AUTHENTICATION”, “TRANSACTIONKEY” and “DATA” fields.

b) Calculates the packet check sum, using described algorithm.

c) Compares the retrieved result with the “VALIDATION” field value.

Security Considerations

Considering the functioning of the algorithm of both client and server, there are several security considerations to address. The following is a list of some example security considerations.

1. The server knows the client secret code for client authentication.

2. The client knows its own secret code for successful authentication by the server.

3. The client does not know the server secret code for successful authentication by the server.

4. If the client information is absent in the server database, the client will not be authenticated by the server.

5. The server may notify the client about any successful authentication or denial of access, or may stay silent.

6. If the data was changed while transmitted thru channels between applications, the “VALIDATION” field will contain the wrong packet and this fact will be determined by the STAP program application.

7. If the data was changed and the check sum was recalculated, the client will receive the session key and transaction key, but these keys will not contain valid server keys. Therefore, the interaction between applications will be difficult. If the next client packet, created with these wrong keys, is intercepted from communication channels by a hacker, the hacker will not retrieve the client secret code from this packet, because the session key is used instead of the client secret code in usual transactions.

8. Using the XOR operation for keys protection makes it difficult to conduct a statistic or cryptographic analysis, and leaves only one way for non-authorized access to the server, which is a brute force attack using all possible secret codes of each client for authentication. This method for non-authorized access is often not very effective, especially in the situation when monitoring software is used.

9. The data protection functions may be used with any known algorithm, depending on the data length and security level.

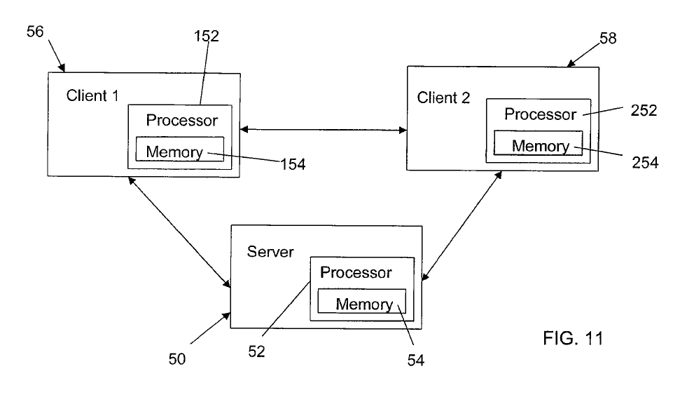

The various methods and processes described above can be embodied in any type of software and /or hardware. FIG. 11 is a schematic illustration of a system according to an embodiment of the invention. The system includes a server 50 configured to provide STAP communications, transaction and authentication protection between clients and/or between a client and the server as described above. The server 50 according to an embodiment of the invention can be located within a client application or network and/or located such that it is accessible or in communication with a client application or network. The server 50 includes a processor 52. The server 50 can be accessible by one or more client applications and be in communication with one or more client applications (e.g., individual computers, networks, etc.) via a broadband connection or other high-speed network. The processor 52 can be, for example, a commercially available personal computer, or a less complex computing or processing device that is dedicated to performing one or more specific tasks. For example, the processor 52 can be a terminal dedicated to providing an interactive graphical user interface (GUI). The processor 52, according to one or more embodiments of the invention, can be a commercially available microprocessor. Alternatively, the processor 52 can be an application-specific integrated circuit (ASIC) or a combination of ASICs, which are designed to achieve one or more specific functions, or enable one or more specific devices or applications. In yet another embodiment, the processor 52 can be an analog or digital circuit, or a combination of multiple circuits.

The processor 52 can include a memory component 54. The memory component 54 can include one or more types of memory. For example, the memory component 54 can include a read only memory (ROM) component and a random access memory (RAM) component. The memory component 54 can also include other types of memory that are suitable for storing data in a form retrievable by the processor 52. For example, electronically programmable read only memory (EPROM), erasable electronically programmable read only memory (EEPROM), flash memory, as well as other suitable forms of memory can be included within the memory component 54. The processor 52 can also include a variety of other components, such as for example, co-processors, graphic processors, etc., depending upon the desired functionality of the code.

The processor 52 is in communication with the memory component 54, and can store data in the memory component 54 or retrieve data previously stored in the memory component 54. The components of the processor 52 can communicate with devices external to the processor 52 by way of an input/output (I/O) component (not shown). According to one or more embodiments of the invention, the I/O component can include a variety of suitable communication interfaces. For example, the I/O component can include, for example, wired connections, such as standard serial ports, parallel ports, universal serial bus (USB) ports, S-video ports, local area network (LAN) ports, small computer system interface (SCSI) ports, and so forth. Additionally, the I/O component can include, for example, wireless connections, such as infrared ports, optical ports, Bluetooth® wireless ports, wireless LAN ports, or the like. The network to which the processor 52 is connected can be physically implemented on a wireless or wired network, on leased or dedicated lines, including a virtual private network (VPN).

A system and method of the invention can be accessed and operated via the server 50. As shown in FIG. 11, a first client application can include a server 56 that can include a processor 152 with a memory 154 as described above for the server 50. And a second client application can include a server 58 having a processor 252 with a memory 254. In some embodiments, a third-party server (not shown) can be used, e for example, to manage and control a STAP system and act as an intermediary between the server 50 and one or more clients. The server 50 can manage and control the communications, interactions, transactions, etc., between the first client and the second client application. Although only two client applications are illustrated, it should be understood that the STAP system can be used for any number of client applications. For example, a client application can include a networks of applications.

As stated above, in some embodiments, one or more clients can be in communication with the server 50 and/or a third-party server. In some embodiments, communications (e.g., transfers of documents) between a first client system and a server on which a system according to an embodiment of the invention is located, can be via the Internet. In such an embodiment, data can be transmitted between the parties via email, a shared access website, etc.

### Conclusion

While various embodiments of the invention have been described above, it should be understood that they have been presented by way of example only, and not limitation. Thus, the breadth and scope of the invention should not be limited by any of the above-described described embodiments, but should be defined only in accordance with the following claims and their equivalents.

The previous description of the embodiments is provided to enable a person skilled in the art to make and/or use the invention. While the invention has been particularly shown and described with reference to embodiments thereof, it will be understood by those skilled in art that various changes in form and details may be made therein without departing from the spirit and scope of the invention. For example, the various configurations of a STAP system may include other features not specifically illustrated, while still remaining within the scope of the invention. Thus, various combinations and sub-combinations of the components and/or capabilities described herein can be included in an embodiment of a system according to the invention.

What is claimed is:

1. A processor-readable medium storing code representing instructions to cause a processor to perform a process, the code comprising code to:
receive at a server a packet from an application including information associated with the application in a sender field and a numeric representation of a connect function in a command field; and
create a response packet, the create a response packet including code to:
place a unique client identifier and a client/sender relation identifier in a sender field;
generate a session key associated with the application;
generate a transaction key associated with the application;
calculate a packet check sum associated with the application and place the packet check sum in a validation field;
combine the transaction key with the session key using an XOR operation and place a result of the combination into a transaction key packet field;
calculate a hash-function associated with a secret code of the application and combine the hash-function with the session key using an XOR operation and place a result of the combination in an authentication packet field;
calculate a packet size and place the packet size into a length packet field.

2. The processor-readable medium of claim 1, further comprising code to:
send the response packet to the application.

3. The processor-readable medium of claim 1, further comprising code to:
create a failed authentication notification packet; and
send the failed authentication notification packet to the application.
